(19) United States
(12) Patent Application Publication
(10) Pub. No.: US 2017/0040087 A1
(43) Pub. Date: Feb. 9, 2017

(54) CABLE ARRANGEMENT

(71) Applicant: Rosenberger Hochfrequenztechnik GmbH & Co. KG, Fridolfing (DE)

(72) Inventors: Gunnar Armbrecht, Deutschhland (DE); Thomas Müller, Deutschland (DE); Stephan Kunz, Deutschland (DE)

(21) Appl. No.: 15/304,200

(22) PCT Filed: Apr. 9, 2015
(86) PCT No.: PCT/EP2015/000754

§ 371 Date: Oct. 14, 2016

(30) Foreign Application Priority Data
Apr. 16, 2014 (DE) 20 2014 003 291.2

(51) Int. Cl. H01B 11/04; H01B 11/00; H01B 7/00

(52) U.S. Cl. CPC H01B 11/04; H01B 7/0045; H01B 11/005

(57) ABSTRACT

An arrangement of at least two adjacently extending cables, of which a first cable and a second cable which each have at least one stranding group that has two or more conductors stranded to each other and which each have a common cable sheath surrounding the stranding group, a spacer being provided outside on at least one of the cable sheaths for increasing a minimum distance (A) between the stranding groups of the two cables.

### BACKGROUND OF THE INVENTION

1. Field of the Invention

The invention relates to an arrangement of at least two adjacently extending cables, of which a first cable and a second cable each have at least one stranding group which has two or more conductors which are stranded together and each have a common cable sheath surrounding the stranding group.

2. Description of Related Art

A twisting or stranding is generally understood to mean the twisting around each other in a helical manner of several wires or conductors of a cable. For example, a known twisted-pair cable has at least one stranding group which comprises two conductors which are twisted around one another. The individual conductors thereby change places in the longitudinal direction of the cable. In addition, twisted or stranded wire pairs offer better protection against external alternating electromagnetic fields and electrostatic interference.

The common cable sheath, which is usually formed of a dielectric such as plastic, surrounds the conductors (the wires), which are each provided with individual insulation.

A crosstalk between several conductor pairs running adjacent to one another in a cable can also be effectively reduced through stranding. In addition, differing lay lengths and/or directions of rotation of the individual stranding groups of a cable can be chosen. An external signal from a first conductor pair can be coupled into an adjacent second conductor pair inductively or capacitively.

Such undesired crosstalk between the cables (alien crosstalk) can also occur if several cables which each have at least one conductor pair for the transmission of differential signals are laid adjacent to one another. In order to reduce this crosstalk, the individual cables are regularly provided with a shielding. Alternatively, coaxial cables are used.

The document U.S. Patent Publication No. 2012/0186846 describes arranging several stranding groups in a cable, whereby the stranding groups can in turn be twisted together. The lay lengths of the individual strandings can vary. However, the manufacture of such a cable is particularly complex. Also, alien crosstalk can occur between several such cables which are laid adjacent to one another.

The document EP 21 31 370 B1 also describes stranding two stranding groups together with one another, whereby the lay length of the group stranding varies sinusoidally. This cable too is complex to manufacture. Also, alien crosstalk can occur between several such cables which are laid adjacent to one another. The lay length is understood to mean the pitch or turn distance of the helix traced by the stranding group. In other words, the lay length is the distance over which one of the stranded wires of a stranding group twists during a complete rotation in the longitudinal direction of the cable (z-direction).

### SUMMARY OF THE INVENTION

In view of the problems described, it is the object of the present invention to provide an arrangement of several cables running adjacent to one another which are each suitable for the transmission of differential signals, wherein the arrangement is simple to manufacture, and wherein a crosstalk between the conductor pairs of the individual cables is at the same time reliably prevented or at least minimized.

A shielding of the individual cables should thereby preferably be omitted, since on the one hand this is expensive and on the other hand this can have a negative effect on the weight and flexibility of the cable.

This problem is solved according to the invention through a cable arrangement according to the independent claims. Advantageous further developments of the invention are described in the dependent claims.

The above and other objects, which will be apparent to those skilled in the art, are achieved in the present invention which is directed to a cable arrangement of at least two adjacently extending cables, of which a first cable and a second cable each have exactly one stranding group which has two or more conductors which are stranded together and each have a common cable sheath surrounding the stranding group, wherein the stranding groups in each case consists of a twisted conductor pair and/or that the cables are in each case twisted-pair cables, or wherein the cables are in each case star quad cables with quad stranding, wherein a spacer is arranged on the outside of at least one of the cable sheaths in order to increase a minimum spacing (A) between the stranding groups of the two cables.

The spacer may be arranged on the outside of each of the cable sheaths. Furthermore, the spacer may be configured as a sleeve with a round or oval outer contour surrounding the cable sheath coaxially, where the sleeve extends over more than 30%, over more than 50%, over more than 75%, or over the entire length of the cable.

The spacer may also comprise an additional cable sheath arranged on the outside of the cable sheath.

Preferably, the spacer comprises a non-conductive material, such as a plastic material and/or a foam material, and/or a foamed plastic polypropolene PP.

In at least one embodiment, an outer diameter (X) of the spacer is more than 1.25 times, or more than 1.5 times, as great as an outer diameter (Y) of the cable sheath. More particularly, the outer diameter (X) of the spacer may be greater than 3.5 mm and less than 10 mm, greater than 4 mm and less than 5 mm, and/or the outer diameter (Y) of the cable sheath may be greater than 2 mm and less than 3.5 mm.

The cable arrangement is preferably in the form of a cable bundle containing more than two, or five or more cables, such that not all cables run in the same plane.

### BRIEF DESCRIPTION OF THE DRAWINGS

The features of the invention believed to be novel and the elements characteristic of the invention are set forth with particularity in the appended claims. The FIGURE is for illustration purposes only and are not drawn to scale. The invention itself, however, both as to organization and method of operation, may best be understood by reference to the detailed description which follows taken in conjunction with the accompanying drawing in which:

FIG. 1 depicts an arrangement according to the invention consisting of two cables which, at least in sections, run adjacent to one another.

### DESCRIPTION OF THE PREFERRED EMBODIMENT(S)

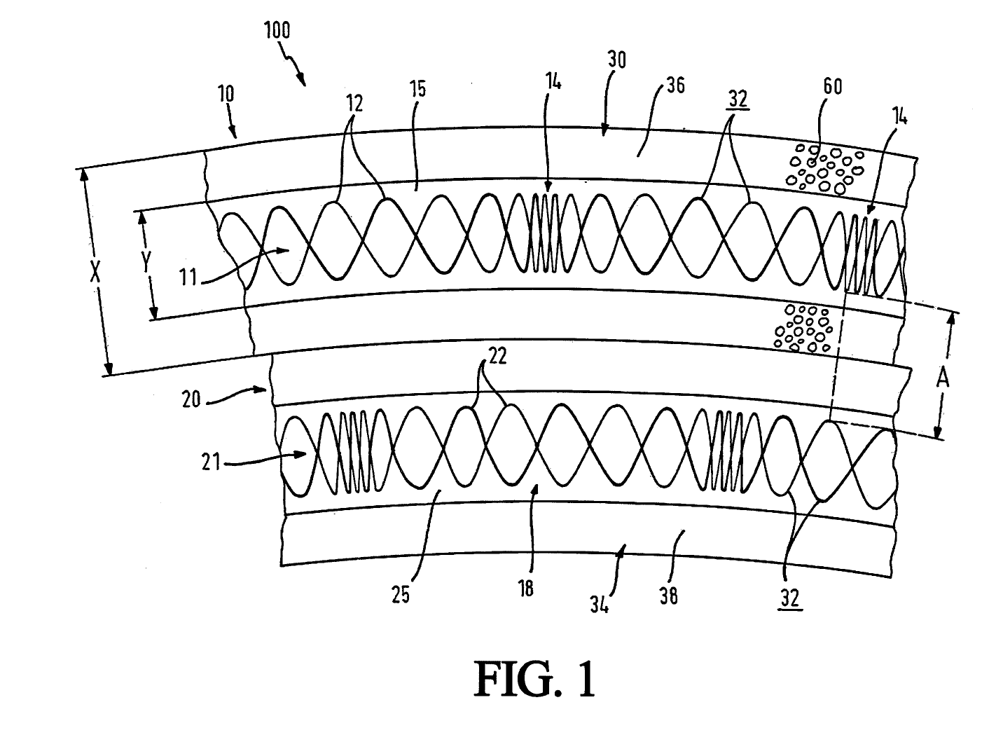

In describing the preferred embodiment of the present invention, reference will be made herein to FIG. 1 in which like numerals refer to like features of the invention.

In the cable arrangement according to the invention, at least one of the cable sheaths has a spacer arranged on the outside thereof in order to increase a (minimum) spacing between the stranding groups of the two cables.

The individual cables of the arrangement can be arranged next to one another such that they lie with their external lateral boundary surfaces in contact, at least in sections, whereby in this case the (smallest possible) spacing between the two stranding groups, starting out from an outer surface of the cable sheath, is increased through the spacer at least by a dimension corresponding to the radial thickness of the spacer. This radial thickness of the spacer can thereby be designed, depending on parameters such as the signal strength to be transmitted, the cable sheath diameter, the number of stranded conductors per stranding group, the number of cables in the cable arrangement as well as their arrangement relative to one another (in a plane or in the form of a three-dimensional bundle) such that the alien crosstalk between the stranding groups of the individual cables is damped to a predetermined desired extent through the increase in or provision of the minimum spacing between the stranding groups.

According to the invention, a spacer is preferably arranged on the outside of each of the cable sheaths. In other words, each individual cable of the arrangement has at least one spacer which can be attached to the outside of the cable sheath. In this case the spacing between the two stranding groups is increased through the spacer at least by a dimension corresponding to twice the radial thickness of a spacer or the combined radial thickness of the two spacers. Irrespective of the layout of the individual cables, this can prevent the stranding groups from coming closer to one another than a predetermined minimum spacing A.

The invention is based on the knowledge that a crosstalk between adjacent stranding groups is reduced with increasing spacing between the stranding groups. A considerable undesired alien crosstalk can therefore occur between stranding groups running closely next to one another. However, this problem can only be remedied to an inadequate degree through known measures such as a variation in the lay length between the individual stranding groups of the cables. It is conceivable, when laying conventional cables, to ensure that a specified minimum spacing between the cables is maintained. However, meeting such a specification is laborious and time-consuming for the cable installer. The undesired alien crosstalk can be particularly pronounced in the case of a cable bundle with numerous cables running parallel to one another, since in this case each cable has several neighboring cables which may lie very close to them. According to the invention, this problem can be remedied through the spacer attached to the outside of the cables, since this ensures a specified minimum spacing between adjacent stranding groups, even in the case of a bundled arrangement of the cables.

In a preferred embodiment of the invention, the spacer is designed in the form of a sleeve with preferably round or oval outer contour surrounding the cable sheath coaxially. If the sleeve has a round shape in cross section, several cables, each surrounded by such a sleeve, can be laid in bundled form in the form of a particularly dense cable packing, whereby the individual sleeves can lie adjacent to one another.

In a first alternative of the invention, several sleeves, spaced apart in the longitudinal direction of the cable, are provided on the outside of the cable or on each cable which each have only a short dimension in the longitudinal direction of the cable, for example less than 10 cm. However, in a particularly preferred alternative of the invention the sleeve extends in the longitudinal direction over a greater length, for example more than 1 m, in particular 3 m or more and is flexible, like the rest of the cable, in order to ensure, over this entire region, that the stranding groups of the cables do not come too close. It has thereby proved practical for the sleeve to extend over more than 30%, preferably over more than 50%, particularly preferably over more than 75%, in particular over the entire length of the cable, so that an alien crosstalk between the cables is reliably suppressed over the entire length of the cable.

A spacer in the form of an additional cable sheath arranged on the cable sheath has proved particularly practical and economical to manufacture. Such an additional cable sheath effectively increases the overall diameter of the individual cables. The additional cable sheath can be fixed to the outside of the cable sheath in a force-locking and/or form-locking manner, for example pushed onto it and/or attached in a form-locking manner by adhesive bonding or spraying, for example.

A non-conductive material, preferably a plastic material and/or a foam material, has proved to be an easily worked material for the spacers. A foam material has the advantage that the diameter of the cable can be enlarged through a foam sheath using only a limited amount of material, so that the spacing between the stranding groups can be increased significantly without greatly increasing the weight of the cable arrangement. Preferably, the spacer consists of a foamed plastic, for example polypropylene PP.

In order to achieve a satisfactory suppression of crosstalk, it has proved advantageous for the outer diameter of the spacer to be more than 1.25 times, in particular more than 1.5 times as great as the outer diameter of the cable sheath.

The outer diameter of the spacer can thereby be greater than 3.5 mm and less than 10 mm, in particular greater than 4 mm and less than 5 mm.

Alternatively or additionally, the outer diameter of the cable sheath can be greater than 2 mm and less than 3.5 mm. These dimensions offer an advantageous compromise in terms of involving only a slight increase in the weight of the cable arrangement while at the same time achieving a satisfactory suppression of alien crosstalk. Preferably, the stranding groups in each case consist of a twisted conductor pair. The cables can in each case be twisted-pair cables, in each case with one or more twisted conductor pairs.

Alternatively, the stranding groups can in each case consist of four conductors stranded together. The cables can in this case each be star quad cables with quad stranding.

The advantageous effects of the invention are manifested particularly clearly if each stranding group has at least one conductor pair for transmitting a differential signal, because such conductor pairs running adjacent to one another are particularly susceptible to alien crosstalk.

A cable arrangement according to the invention providing controllable suppression of the alien crosstalk between the stranding groups is particularly simple to manufacture if each cable has exactly one stranding group.

The cable arrangement according to the invention is preferably in the form of a cable bundle containing more than two, in particular five or more cables, of which at least one cable does not lie in the plane spanned by the two other cables. At least one cable can thereby have more than one neighboring cable, for example two, three of four neighboring cables, which run in contact with it, at least in sections. The outer surfaces of the spacers of adjacent cables can in each case thereby be in contact with one another, at least in sections, ensuring an increased minimum spacing between the stranding groups.

In a preferred embodiment, the at least two cables are separate individual cables which preferably run adjacent to one another in the form of a bundle. Alternatively or additionally, the cable can, at least in sections, be guided next to one another in guides and/or be held in a common mounting. It is not necessary, but possible, that the cables run parallel with one another over their entire length. They can also only run parallel or substantially parallel with one another in sections if, for example, they are held at one end in a common cable connector, mounting etc. As an additional measure for suppressing alien crosstalk between the stranding groups, the lay lengths of the individual stranding groups can be varied. In this connection, reference is made in particular to the German patent application with the reference number 10 2014 000 897.5, the content of which is included in the present disclosure by way of reference.

The invention is explained in detail in the following description with reference to the drawing. The sole drawing in FIG. 1 shows, in the form of a schematic sketch, an arrangement 100 according to the invention consisting of two cables 10, 20 which, at least in sections, run adjacent to one another.

It is indicated that two conductors 32 (wires), stranded or twisted together and each provided with insulation (not shown), run within each of the cables 10, 20. Two wires stranded together in each case form a stranding group 11, 21. In other words, the wires of a stranding group are wound around one another in a screw-like or helical form. With each full rotation, each of the stranded wires advances by one lay length in the longitudinal direction of the cable.

The first cable 10 is a twisted-pair cable and comprises exactly one stranding group 11 which comprises two twisted-together conductors 32. In order to form the cable 10 the stranding group 11 is surrounded by a cable sheath 15 made of an insulating material, whereby the diameter Y of the cable sheath is around 3.2 mm. Other diameters are alternatively possible. The cable sheath 15 is surrounded by a spacer 30 in the form of an additional cable sheath 36 which coaxially surrounds the inner cable sheath 15.

The second cable 20 is also a twisted-pair cable and comprises exactly one stranding group 21 which comprises two twisted-together conductors 32. The stranding group 21 is surrounded by a cable sheath 25 made of an insulating material. The cable sheath 25 is surrounded by a spacer 34 in the form of an additional cable sheath 38 which coaxially surrounds the inner cable sheath 25.

The lay lengths of the stranding groups 11, 21 of the two cables 10, 20 vary sinusoidally in the longitudinal direction of the cable between a minimum lay length and a maximum lay length, so that stranding sections of minimum lay length 14 and stranding sections of maximum lay length 18 are formed. This reduces the crosstalk between the stranding groups 11, 21.

The illustrated sections of the two cables 10, 20 are laid closely next to one another, so that the outer sides of the additional cable sheaths 36, 38 are in contact with one another. Alternatively, a free space can be provided, at least in sections, between the two additional cable sheaths 36, 38. In the present case, the closely adjacent representation of the two additional cable sheaths 36, 38 was chosen in order to illustrate the smallest possible spacing “A” between the two stranding groups 11, 21. As can be clearly seen from the FIGURE, this smallest possible spacing A is enlarged through the two additional cable sheaths 36, 38 by a dimension corresponding to the combined thickness of the two additional cable sheaths 36, 38. The greater the spacing A between the two stranding groups 11, 21, the more effectively an alien crosstalk between the signals transmitted with the two stranding groups 11, 21 can be reduced.

In the illustrated embodiment, the diameter Y of the cable sheaths 15, 25 is in each case around 3.2 mm, while the diameter X of the additional cable sheaths 36, 38 amounts to between four and five millimeters. Other dimensions are possible depending on the desired reduction in crosstalk between the stranding groups 11, 21.

The additional cable sheaths 36, 38 in each case consist of a foamed plastic, indicated under the reference number 60 through air pockets. This leads to a lightweight cable despite of the enlarged cable diameter Y.

The inner cable sheaths 15, 25 in contrast consist of a conventional (unfoamed) plastic.

The additional cable sheath 36, 38 can also be applied subsequently to the cable sheath 15, 25 of an existing cable, for example it can be sprayed onto the cable sheath 15, 25. Alternatively, it can be pushed onto the inner cable sheath 15, 25 like a sleeve or fitted from the side.

The additional cable sheaths 36, 38 extend over the entire length of the cable, so that a minimum spacing A between the stranding groups of adjacent cables 10, 20 is ensured over the entire length of the cable.

The invention is not limited to the described exemplary embodiment. For example, the arrangement according to the invention can be formed of more than two (2) cables running next to one another. Instead of the twisted-pair cable, star quad cables with a stranding group formed of four (4) wires can be used. Instead of the additional cable sheath, a rigid sleeve or a different form of spacer can be provided which does not necessarily extend over the entire length of the cable.

### LIST OF REFERENCE NUMBERS

10 first cable
11 stranding group of the first cable
12 twisted conductor pair of the first cable
15 cable sheath of the first cable
14, 18 stranding sections
20 second cable
21 stranding group of the second cable
22 twisted conductor pair of the second cable
25 cable sheath of the second cable
30 spacer of the first cable
32 stranded conductor
34 spacer of the second cable
36 additional cable sheath of the first cable
38 additional cable sheath of the second cable
60 air pockets
100 cable arrangement
A spacing between the stranding groups
X outer diameter of the spacer
Y outer diameter of the cable

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A cable arrangement of at least two adjacently extending cables of which a first cable and a second cable each have exactly one stranding group which has two or more conductors which are stranded together and each have a common cable sheath surrounding the stranding group, wherein the stranding groups in each case consists of a twisted conductor pair and/or that the cables are in each case twisted-pair cables, or wherein the cables are in each case star quad cables with quad stranding, wherein a spacer is arranged on the outside of at least one of the cable sheaths in order to increase a minimum spacing (A) between the stranding groups of the two cables.

2. The cable arrangement of claim 1, wherein said spacer is arranged on the outside of each of the cable sheaths.

3. The cable arrangement of claim 1, wherein the spacer is a sleeve with a round or oval outer contour surrounding the cable sheath coaxially.

4. The cable arrangement of claim 3, wherein the sleeve extends over more than 30%, over more than 50%, over more than 75%, or over the entire length of the cable.

5. The cable arrangement of claim 3, wherein the spacer comprises an additional cable sheath arranged on the outside of the cable sheath.

6. The cable arrangement of claim 1, wherein the spacer comprises a non-conductive material.

7. The cable arrangement of claim 1, wherein an outer diameter (X) of the spacer is more than 1.25 times, or more than 1.5 times, as great as an outer diameter (Y) of the cable sheath.

8. The cable arrangement of claim 7, wherein the outer diameter (X) of the spacer is greater than 3.5 mm and less than 10 mm, greater than 4 mm and less than 5 mm and/or the outer diameter (Y) of the cable sheath is greater than 2 mm and less than 3.5 mm.

9. The cable arrangement of claim 1, wherein said cable arrangement is in the form of a cable bundle containing more than two, or five or more cables, such that not all cables run in the same plane.

10. The cable arrangement of claim 2, wherein the spacer is a sleeve with a round or oval outer contour surrounding the cable sheath coaxially.

11. The cable arrangement of claim 4, wherein the spacer comprises an additional cable sheath arranged on the outside of the cable sheath.

12. The cable arrangement of claim 11, wherein the spacer comprises a non-conductive material.

13. The cable arrangement of claim 11, wherein an outer diameter (X) of the spacer is more than 1.25 times, or more than 1.5 times, as great as the an outer diameter (Y) of the cable sheath.

14. The cable arrangement of claim 6 wherein said non-conductive comprises a plastic material and/or a foam material, and/or a foamed plastic polypropolene PP.

15. The cable arrangement of claim 13, wherein the outer diameter (X) of the spacer is greater than 3.5 mm and less than 10 mm, greater than 4 mm and less than 5 mm, and/or the outer diameter (Y) of the cable sheath is greater than 2 mm and less than 3.5 mm
